(19) United States
(12) Patent Application Publication
(10) Pub. No.: US 2026/0180036 A1
(43) Pub. Date: Jun. 25, 2026

(54) SEPARATOR, MANUFACTURING METHOD THEREOF, AND ELECTROCHEMICAL DEVICE INCLUDING THE SAME

(71) Applicant: LG ENERGY SOLUTION, LTD., Seoul (KR)

(72) Inventors: Won-Sik BAE, Daejeon (KR); So-Yeong LEE, Daejeon (KR); Byeong-Chan BAK, Daejeon (KR); Kyeong-Hui BAE, Daejeon (KR); In-Young CHOI, Daejeon (KR)

(21) Appl. No.: 19/365,024

(22) Filed: Oct. 21, 2025

(30) Foreign Application Priority Data
Oct. 22, 2024 (KR) 10-2024-0145251

(51) Int. Cl. H01M 10/42; H01M 50/403; H01M 50/417; H01M 50/446; H01M 50/449; H01M 50/489

(52) U.S. Cl. CPC H01M 10/4235; H01M 50/403; H01M 50/417; H01M 50/446; H01M 50/449; H01M 50/489

(57) ABSTRACT

A separator of a secondary battery includes a polyolefin-based porous substrate having a thickness of about 8 μm or less. The total pore volume within the polyolefin-based porous substrate is about 0.45 cc/g to 1.5 cc/g.

### CROSS-REFERENCE TO RELATED APPLICATIONS

This application is based on and claims priority from Korean Patent Application No. 10-2024-0145251 filed on Oct. 22, 2024, with the Korean Intellectual Property Office, the disclosure of which is incorporated herein in its entirety by reference.

### TECHNICAL FIELD

The present disclosure relates to a separator, a manufacturing method thereof, an electrode assembly, and an electrochemical device including these.

### BACKGROUND

A lithium secondary battery is manufactured through a process in which an electrode assembly including a positive electrode/a separator/a negative electrode as one unit is inserted into a battery case, an electrolyte is injected into the battery case, and sealing is performed in the battery case. The separator functions to prevent or suppress a direct physical contact between the positive electrode and the negative electrode. As for the separator for use in the lithium secondary battery, for example, a polyolefin-based porous substrate is used.

In recent years, research on the weight reduction of battery materials is ongoing to achieve a high energy density of a lithium secondary battery. In relation to a separator, research is also ongoing to implement a thin film separator that utilizes a conventionally used polyolefin-based porous substrate but is lightweight.

### SUMMARY

The present disclosure provides a separator, and an electrode assembly and an electrochemical device including the same.

The present disclosure provides a thin film separator, as a separator that is one of components of a battery, so as to reduce the weight of an electrochemical device, for example, a lithium secondary battery.

The present disclosure provides a separator that is thin but can secure a sufficient number of pores even after a battery is assembled, a manufacturing method thereof, an electrode assembly employing the same, and an electrochemical device including the same.

According to one aspect of the present disclosure, a separator of the following embodiments is provided.

The separator according to a first embodiment includes a polyolefin-based porous substrate having a thickness of about 8 μm or less, and the total pore volume within the polyolefin-based porous substrate is about 0.45 cc/g to 1.5 cc/g.

According to a second embodiment, in the first embodiment, the total pore volume may be obtained by injecting moisture into the polyolefin-based porous substrate at a constant pressure and measuring the total amount of moisture injected until the moisture saturation reaches 100 volume %.

According to a third embodiment, the thickness of the polyolefin-based porous substrate in the first embodiment or the second embodiment may be about 5 μm to 8 μm.

According to a fourth embodiment, the polyolefin-based porous substrate in any one of the first to third embodiments may be manufactured by a wet method, and the wet method may be a method including an extrusion process and a stretching process using a raw material of a polyolefin-based resin mixed with a diluent.

According to a fifth embodiment, the separator in any one of the first to fourth embodiments may further include a porous coating layer that is located on at least one surface of the polyolefin-based porous substrate, and includes inorganic particles and a binder. The thickness of the porous coating layer formed on one surface may be about 20% to 45% relative to the thickness of the separator.

According to a sixth embodiment, the separator in any one of the first to fifth embodiments may include a porous coating layer on each of the two surfaces of the polyolefin-based porous substrate. The sum of thicknesses of the porous coating layers may be about 40% to 80% relative to the thickness of the separator.

According to another aspect of the present disclosure, a manufacturing method of a separator of the following embodiments is provided.

The manufacturing method of the separator according to a seventh embodiment includes: the steps of extruding, cooling, and molding a mixture of a polyolefin resin raw material and a diluent to obtain a polymer sheet; stretching the obtained polymer sheet in the MD and TD; and heat-setting the stretched polymer sheet to obtain a polyolefin-based porous substrate. The MD stretching may be performed at a stretching ratio of 6 times or more, a difference between the temperature for the TD stretching and the temperature for the MD stretching may be less than 20° C., and the thickness of the polyolefin-based porous substrate may be about 8 μm or less.

According to an eighth embodiment, the MD stretching in the seventh embodiment may be performed at a stretching ratio of about 6 to 10 times at a temperature of about 100° C. to 125° C.

According to a ninth embodiment, the TD stretching in the seventh embodiment or the eighth embodiment may be performed at a stretching ratio of about 4 to 10 times at a temperature of about 125° C. to 135° C.

According to a tenth embodiment, the heat-setting in any one of the seventh to ninth embodiments may be performed at a temperature of about 130° C. to 140° C.

According to an eleventh embodiment, the total pore volume within the polyolefin-based porous substrate in any one of the seventh to tenth embodiments may be about 0.45 cc/g to 1.5 cc/g.

According to a twelfth embodiment, the step of forming a porous coating layer in any one of the seventh to eleventh embodiments may be further included in which a porous coating layer forming slurry containing inorganic particles and a binder is applied to at least one surface of the polyolefin-based porous substrate, and is dried.

According to a thirteenth embodiment, in the formation in any one of the seventh to twelfth embodiments, the thickness of the porous coating layer formed on one surface may be about 20% to 45% relative to the thickness of the separator.

According to another aspect of the present disclosure, an electrode assembly and an electrochemical device of the following embodiments are provided.

The electrode assembly according to a fourteenth embodiment may include the separator according to any one of the first to sixth embodiments, and a positive electrode and a negative electrode which are provided on both surfaces of the separator, respectively.

The electrochemical device according to a fifteenth embodiment may include a case that accommodates the electrode assembly.

According to a sixteenth embodiment, the porous coating layer in the fifth embodiment may be manufactured by a safety reinforced separator (SRS) manufacturing method.

According to a seventeenth embodiment, the extrusion step in the seventh embodiment may be performed through melt-extrusion at a temperature of about 170° C. to 250° C.

The separator according to one embodiment of the present disclosure may include a polyolefin-based porous substrate having a thickness of about 8 μm or less.

In the separator according to one embodiment of the present disclosure, it is possible to achieve an excellent advantage in that despite a small thickness, a sufficient number of pores can be secured even after lamination with electrodes. For example, the polyolefin-based porous substrate may secure a total pore volume of about 0.45 cc/g or more even after lamination with electrodes.

Further, the electrode assembly to which the separator according to one embodiment of the present disclosure is applied may exhibit a low resistance value, and exhibit an advantage such as excellent capacity retention rate over charging/discharging cycles.

Accordingly, the electrochemical device utilizing the separator may exhibit an advantage in excellent life as well as high energy density due to weight reduction.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is a flowchart illustrating a manufacturing method of a separator according to one embodiment of the present disclosure.

### DETAILED DESCRIPTION

In this specification, when it is said that a certain part “includes” a certain component, this means that the certain part may further include other components rather than excluding other components unless specifically stated to the contrary.

In this specification, the description of the term “A and/or B” means “A or B, or both”.

Specific terms used in the following detailed description of the invention are for convenience and are not intended to limit the present disclosure. For example, words indicating directions such as top and bottom are exemplarily used terms for describing positional relationships with respect to a single reference point, and do not limit absolute positional relationships.

“About”, “approximately”, and “substantially” used in this specification are used to mean ranges of numerical values or degrees, or approximations thereof, taking into account inherent manufacturing and material tolerances (e.g., ±5%).

When a positive electrode, a separator, and a negative electrode are stacked to manufacture an electrode assembly and then a battery is assembled by performing an adhesion process such as hot press, in a case where the thickness of the separator is reduced, a problem in which a sufficient number of pores in the separator are not secured may occur. When a sufficient number of pores in the separator are not secured, the resistance of the battery is increased, which causes problems such as reduction of charging/discharging efficiency and reduction of a battery life.

Therefore, electrochemical devices such as lithium secondary batteries are increasingly required to have both safety and high performance. Then, it is necessary to develop a separator that can perform the unique function of the separator while lowering the resistance of the electrochemical device and also improving the life of the battery.

In consideration of this, the present disclosure provides a separator in which a sufficient number of pores can be secured even after assembling of a battery, a manufacturing method thereof, an electrode assembly employing the same, and an electrochemical device including the same.

### Separator

According to one aspect of the present disclosure, a separator including a polyolefin-based porous substrate is provided.

For example, the separator according to one aspect of the present disclosure includes a polyolefin-based porous substrate having a thickness of about 8 μm or less.

Also, the separator according to one aspect of the present disclosure includes a polyolefin-based porous substrate having a total pore volume of about 0.45 cc/g to 1.5 cc/g. The total pore volume within the polyolefin-based porous substrate may be about 0.5 cc/g to 1.5 cc/g or 0.50 cc/g to 1.50 cc/g.

Alternatively, the separator according to one aspect of the present disclosure includes a polyolefin-based porous substrate having a thickness of about 8 μm or less, and the total pore volume within the polyolefin-based porous substrate is about 0.45 cc/g to 1.5 cc/g.

The polyolefin-based porous substrate used as a separator substrate includes a plurality of pores on the surface and/or inside. Even when the separator is interposed between a positive electrode and a negative electrode, it is characterized in that through the plurality of pores, charge transfer and lithium ion transmission are possible between the positive electrode and the negative electrode. However, when the polyolefin-based porous substrate is thin, for example, when the substrate is realized with a thickness of 8 μm or less, it is characterized in that the absolute amount of pores is small compared to a thick film separator. Accordingly, when the separator is compressed with electrodes through lamination, etc. during a battery assembly process, the total pore volume is also reduced. Then, when the total pore volume is too small, problems such as a high resistance value of a finished battery and poor charging/discharging characteristics may be caused.

In order to prevent or suppress these problems, the separator substrate according to one aspect of the present disclosure has a total pore volume of about 0.45 cc/g to 1.5 cc/g.

According to one embodiment of the present disclosure, when the total pore volume within the polyolefin-based porous substrate is within the above-described range, it is advantageous that not only a sufficient compression resistance is achieved during assembling of the battery but also a low battery resistance value can be achieved even after compression. For example, when the total pore volume within the polyolefin-based porous substrate is smaller than the above-described range, the total pore volume becomes too small after the compression of the separator. This may cause a problem such as deterioration of resistance and cycle characteristics of the battery. Also, when the total pore volume within the polyolefin-based porous substrate is larger than the above-described range, conversely, the compression resistance of the separator is deteriorated, and the volume of pores is further reduced after compression. This may cause a problem in which the resistance and cycle characteristics of the battery are further deteriorated.

In this specification, the ‘total pore volume’ indicates a value measured by a water intrusion method. For example, when moisture is permeated into the polyolefin-based porous substrate at a constant pressure, a graph of the cumulative pore volume (volume %) based on a pore size (nm) may be obtained. Here, a point where the pore volume is 100 volume % indicates a state where the moisture saturation is 100 volume %, and moisture does not penetrate beyond that point. Here, the total amount of moisture injected until the moisture saturation reaches 100 volume % may be measured as the total pore volume within the porous substrate.

According to one embodiment of the present disclosure, when the water intrusion method is performed, the moisture may be injected in a pressure range of, for example, about 150 psi to 1,800 psi, but the present disclosure is not limited thereto.

According to one embodiment of the present disclosure, the total pore volume in the polyolefin-based porous substrate may be about 0.45 cc/g to 1.5 cc/g, for example 0.5 cc/g to 1.5 cc/g or 0.50 cc/g to 1.50 cc/g. Alternatively, the total pore volume may be about 0.5 cc/g to 1.45 cc/g, 0.6 cc/g to 1.40 cc/g, 0.64 cc/g to 1.40 cc/g, 0.8 cc/g to 1.40 cc/g, 1.0 cc/g to 1.40 cc/g, 1.05 cc/g to 1.40 cc/g, 1.1 cc/g to 1.4 cc/g, 1.2 cc/g to 1.4 cc/g, or 1.3 cc/g to 1.4 cc/g, but the present disclosure is not limited thereto.

According to one embodiment of the present disclosure, the thickness of the polyolefin-based porous substrate is not particularly limited as long as it is about 8 μm or less. According to one embodiment, in terms of mechanical strength of the separator, the thickness may be, for example, about 3 μm to 8 μm, 4 μm to 8 μm, 5 μm to 8 μm, 6 μm to 8 μm, 7 μm to 8 μm, or 6 μm to 7 μm, 6.5 μm to 7.5 μm, or 7.0 μm, but the present disclosure is not limited thereto.

In this specification, the “thickness” of the polyolefin-based porous substrate may be measured by a known method for measuring the thickness of each component of an electrochemical device. For example, the thickness of the polyolefin-based porous substrate may be measured by using a known thickness measuring device, and may be measured by using, for example, a commercially available thickness measuring device (Mitutoyo, VL-50S-B, tip diameter 9.5 mm, Spherical Radius 10 mm).

In one embodiment of the present disclosure, the polyolefin-based porous substrate may be manufactured by using a polyolefin-based material as a thermoplastic resin to implement a unique function of the separator, so that it is possible to perform a shutdown function while performing an ion conducting barrier function. The ion conducting barrier function allows ions to pass while blocking the contact between the positive electrode and the negative electrode.

In one embodiment of the present disclosure, the polyolefin-based porous substrate refers to a substrate including a material formed through polymerization of olefin, and is not particularly limited as long as the olefin is used for the separator. For example, the olefin may include polyethylene, polypropylene, or a mixture thereof.

According to one embodiment of the present disclosure, the separator may include a polyolefin-based substrate manufactured by a wet method as described below. The polyolefin-based substrate may be manufactured by a wet method or a dry method. Here, the manufacturing may be carried out by a wet method in terms of realizing the polyolefin-based substrate into the form of a thin film, and increasing the uniformity of a pore size.

According to one embodiment of the present disclosure, the separator may further include a binder polymer-containing binder adhesive layer on at least one surface of the polyolefin-based porous substrate in order to improve adhesion with an electrode.

In another embodiment of the present disclosure, in order to enhance the heat resistance, the separator may further include a porous coating layer that is located on at least one surface of the polyolefin-based porous substrate, and includes inorganic particles and a binder. Here, the porous coating layer may be referred to as a heat-resistant coating layer because it contains heat-resistant inorganic particles.

In one embodiment of the present disclosure, the porous coating layer may have a single-layer structure or a multi-layer structure.

According to one embodiment of the present disclosure, when the porous coating layer has a multi-layer structure, in this structure, the inorganic particles may be included in a layer adjacent to the polyolefin-based porous substrate, and a binder layer may be formed on the upper surface of the inorganic particle layer, thereby providing an adhesive layer, but the present disclosure is not limited thereto.

According to one embodiment of the present disclosure, when the porous coating layer has a multi-layer structure, the inorganic particles and the binder may be included in a layer adjacent to the polyolefin-based porous substrate and an additional binder adhesive layer may be further included to provide additional adhesive strength to the outermost surface layer, but the present disclosure is not limited thereto.

According to one embodiment of the present disclosure, the separator may not include a heat-resistant coating layer including inorganic particles and a binder polymer, and may use only the polyolefin-based substrate alone. For example, the separator may be made of only the polyolefin-based substrate.

According to another embodiment of the present disclosure, the separator may be made of only the polyolefin-based substrate and the binder adhesive layer.

According to yet another embodiment of the present disclosure, the separator may be made of the polyolefin-based substrate, the heat-resistant coating layer formed on at least one surface of the polyolefin-based substrate, and the binder adhesive layer formed on one surface of the heat-resistant coating layer. Here, one surface of the heat-resistant coating layer means the surface where the separator and the electrode face each other during bonding between the separator and the electrode.

In one embodiment of the present disclosure, when the separator further includes the porous coating layer, the thickness of the porous coating layer is not particularly limited as long as its range does not impede the purpose of the present disclosure, that is, a thin film formation of the separator. For example, the thickness of the porous coating layer formed on one surface of the polyolefin-based porous substrate may be about 20% to 45% relative to the thickness of the separator. For example, the thickness of the porous coating layer formed on one surface of the polyolefin-based porous substrate may be about 20% to 40%, 25% to 40%, 30% to 40%, 30% to 38%, 30% to 35%, or 31% to 36% relative to the thickness of the separator, but the present disclosure is not limited thereto.

In one embodiment of the present disclosure, when the porous coating layer is formed on each of the two surfaces of the polyolefin-based porous substrate, the sum of thicknesses of the porous coating layers may be about 40% to 80% relative to the thickness of the separator. For example, the sum of thicknesses of the porous coating layers in the separator may be about 40% to 80%, 50% to 80%, 60% to 80%, 60% to 75%, or 62% to 72%, for example, about 62.5% to 71% relative to the thickness of the separator, but the present disclosure is not limited thereto.

In one embodiment of the present disclosure, the binder that can be used for the porous coating layer may be used without particular limitation as long as its material can exhibit an adhesive force when used in the separator. For example, as for the binder, a polyvinylidene fluoride-based resin (PVdF-based resin), an acrylic resin, a rubber-based resin, or a mixture of two or more types of these may be used, but the present disclosure is not limited thereto.

In one embodiment of the present disclosure, the inorganic particles that can be used for the porous coating layer may be used without particular limitation as long as they are electrochemically stable. For example, the inorganic particles may be used without particular limitation as long as they do not undergo oxidation and/or reduction reactions in the operating voltage range (e.g., 0 to 5 V based on Li/Li+) of an electrochemical device to which the separator is applied. Examples of the inorganic particles may include BaTiO₃, Pb(Zr,Ti)O₃ (PZT), Pb₁₋ₓLaₓZr_{1-y}Ti_{y}O₃ (PLZT, 0<x<1, 0<y<1), Pb(Mg_{1/3}Nb_{2/3})O₃—PbTiO₃(PMN-PT), hafnia (HfO₂), SrTiO₃, SnO₂, CeO₂, MgO, NiO, CaO, ZnO, ZrO₂, SiO₂, Y₂O₃, Al₂O₃, SiC, and TiO₂, and one or two or more of these may be included, but the present disclosure is not limited thereto.

In one embodiment of the present disclosure, when the separator further includes the porous coating layer, the average particle diameter (D₅₀) of the inorganic particles may be, for example, about 100 nm or more so that the pores of the separator may be prevented from being clogged by the inorganic particles and the porosity of the separator may not be reduced. For example, the average particle diameter (D₅₀) of the inorganic particles may be about 100 nm to 1 μm, or may be about 100 nm to 500 nm, but the present disclosure is not limited thereto.

In this specification, the particle diameter of the inorganic particles may be measured by a known particle size measurement method, and may be measured by using, for example, a particle size analyzer (PSA) of Malvern. Also, the average particle diameter (D₅₀) refers to a particle diameter at the point of 50% in the volume cumulative distribution based on the particle diameter, and may be measured through a known laser diffraction method. Here, as for the laser diffraction particle size measuring device, for example, Microtrac S3500 of Microtrac may be used.

The separator according to one embodiment of the present disclosure basically has a compression resistance (e.g., compressibility) by including the polyolefin-based porous substrate, and thus has an advantage in that porosity is exhibited even after lamination with electrodes during a battery assembly process. For example, after lamination with electrodes, the separator may have a total pore volume of about 0.5 cc/g or more. The total pore volume refers to the total volume of pores within the polyolefin-based porous substrate in the separator. The post-lamination total pore volume of the separator may be measured on the target separator after the laminated electrodes are removed. Also, when the separator includes the polyolefin-based porous substrate and the porous coating layer formed on the polyolefin-based porous substrate, the post-lamination total pore volume of the separator may be measured after the porous coating layer is removed from the separator.

In one embodiment of the present disclosure, the post-lamination total pore volume of the separator may be about 0.5 cc/g or more, or may be, for example, about 0.5 cc/g to 1.5 cc/g, 0.5 cc/g to 1.0 cc/g, 0.50 cc/g to 1.0 cc/g, 0.52 cc/g to 0.96 cc/g, 0.6 cc/g to 0.96 cc/g, or 0.8 cc/g to 0.96 cc/g, but the present disclosure is not limited thereto.

In one embodiment of the present disclosure, the post-lamination total pore volume of the separator may be measured by the same method as the total pore volume measuring method of the polyolefin-based porous substrate.

In one embodiment of the present disclosure, in order to measure the post-lamination total pore volume of the separator, the lamination may be performed for 10 sec under conditions of, for example, 60° C. and 6.5 MPa, but the present disclosure is not limited thereto.

### Manufacturing Method of Separator

Hereinafter, the manufacturing method of the separator according to one aspect of the present disclosure will be described. However, the manufacturing method to be described below is merely an example of the manufacturing method of the separator, but the manufacturing method of the separator is not limited thereto.

According to one embodiment of the present disclosure, the polyolefin-based porous substrate within the separator may be manufactured by a wet method.

In this specification, the wet method refers to a method including an extrusion process and a stretching process using a raw material of a polyolefin-based resin mixed with a diluent.

Hereinafter, the manufacturing method of the separator according to one aspect of the present disclosure will be exemplarily described.

According to another aspect of the present disclosure, the manufacturing method of the separator is provided.

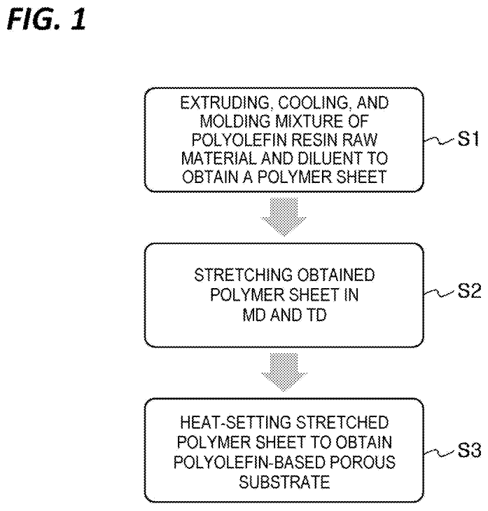

Referring to FIG. 1, the manufacturing method of the separator may include the steps of:
(S1) extruding, cooling, and molding a mixture of a polyolefin resin raw material and a diluent to obtain a polymer sheet;
(S2) stretching the obtained polymer sheet in the MD and TD, and
(S3) heat-setting the stretched polymer sheet to obtain a polyolefin-based porous substrate.

In the manufacturing method of the separator according to one aspect of the present disclosure, the polyolefin-based porous substrate may be manufactured with a thickness of about 8 μm or less.

Also, in the manufacturing method of the separator according to one aspect of the present disclosure, the polyolefin-based porous substrate may be manufactured with a total pore volume ranging from about 0.45 cc/g to 1.5 cc/g, but the present disclosure is not limited thereto.

According to one embodiment of the present disclosure, the polyolefin-based porous substrate is formed by using a polyolefin resin as a raw material, and processing the polyolefin resin into a polymer sheet through a series of high-temperature extrusion, cooling and stretching processes. Here, the polymer sheet has a characteristic that the characteristics of pores formed on the surface thereof change according to the temperature and pressure applied during the manufacturing process. In manufacturing a porous polymer substrate, a polyethylene resin may be included as the polyolefin resin, so that the polymer sheet is manufactured without being damaged during this series of processes. Meanwhile, besides the polyethylene resin, any polyolefin-based resin may be used without limitation.

In one embodiment of the present disclosure, as for the polyolefin resin, for example, those having a weight average molecular weight (Mw) of about 500,000 g/mol to 5,000,000 g/mol may be included. For example, the polyolefin resin having a weight average molecular weight of about 500,000 g/mol to 2,000,000 g/mol, 500,000 g/mol to 1,000,000 g/mol, 500,000 g/mol to 800,000 g/mol, 500,000 g/mol to 700,000 g/mol or 550,000 g/mol to 650,000 g/mol may be used. Alternatively, the polyolefin resin having a weight average molecular weight of, for example, about 600,000 g/mol may be used, but the present disclosure is not limited thereto.

Here, the weight average molecular weight of the polymer may represent a value measured by a measurement method according to one embodiment, and may represent a value measured by using, for example, a gel permeation chromatograph (GPC). Here, the measurement may be carried out with reference to the following conditions as the GPC measurement conditions, but the present disclosure is not limited thereto.
Column: PL Olexis (Polymer Laboratories)
Solvent: TCB (Trichlorobenzene)
Flow rate: 1.0 ml/min
Sample concentration: 1.0 mg/ml
Injection volume: 200 μl
Column Temperature: 160° C.
Detector: Agilent High Temperature RI detector
Standard: Polystyrene (corrected by a cubic function)

In the step (S1), a raw material including the above-described polyolefin resin is extruded to obtain an extrudate, and the high-temperature extrudate is cooled and molded to obtain a polymer sheet.

In one embodiment of the present disclosure, the extrusion may be carried out by a polymer extrusion process in the manufacturing field of the separator. For example, as for an extruder for the extrusion, a single-screw compressor or a twin-screw compressor may be used, but the present disclosure is not limited thereto.

In one embodiment of the present disclosure, the extrusion may be carried out by introducing the polyolefin resin and the diluent into an extruder, and performing melt-extrusion at a temperature of, for example, about 170° C. to 250° C., for example, a temperature of 200° C.

In one embodiment of the present disclosure, the extrusion may be carried out by using a diluent that is used for diluting raw materials in the separator manufacturing process. The diluent refers to a material that is mixed with a polyolefin-based resin to form an extrudate and then undergoes phase separation during cooling and is removed to form pores. The diluent is not particularly limited as long as it satisfies this function. Non-limiting examples of such a diluent may include: aliphatic hydrocarbon solvents such as paraffin oil; vegetable oils such as soybean oil; and plasticizers such as dialkyl phthalate, but the present disclosure is not limited thereto. Among these, liquid paraffin oil having excellent compatibility with the polyolefin-based resin, for example, paraffin oil having a kinematic viscosity of 20 to 200 cSt at 40° C., may be suitably used. The diluents may be used individually or in the form of a mixture of two or more types.

In one embodiment of the present disclosure, the extruded melt may be discharged through a die, and here, the thickness of the polyolefin-based porous substrate to be manufactured can be controlled by adjusting the amount of discharge.

In one embodiment of the present disclosure, the discharge may be performed such that the polyolefin-based porous substrate to be manufactured can be realized with a thickness of about 8 μm or less.

Next, after the extrudate is obtained, the extrudate may be cooled to obtain a polymer sheet (polymer pre-sheet).

According to one embodiment of the present disclosure, the above-obtained extrudate may be molded into a sheet shape by using a cooling casting device at a temperature of about 20° C. to 60° C. For example, the extrudate discharged from the extrusion unit may be allowed to pass between a pair of cooling casting rolls at a temperature of 40° C. and a running speed of 7 m/min. Then, the extrudate may be molded into a polymer sheet shape while being cooled.

In the step (S2), the obtained polymer sheet is stretched in each of the machine direction (MD) and the transverse direction (TD) perpendicular thereto.

In one embodiment of the present disclosure, the step (S2) may include a process of sequentially stretching the polymer pre-sheet in the machine direction and the transverse direction.

In one embodiment of the present disclosure, the total volume of pores formed in the polymer sheet may be modified according to the MD and TD stretching ratios and/or temperatures. Therefore, the MD and TD stretching temperatures and/or ratios may be adjusted as follows such that the total pore volume of the obtained polyolefin-based porous substrate may be realized in a range of about 0.45 cc/g to 1.5 cc/g.

According to one embodiment of the present disclosure, the MD stretching may be performed at a stretching ratio of about 6 times or more so as to exhibit an advantageous effect in terms of increasing the amount of pore formation in the early stage of the stretching process. For example, the MD stretching may be performed at a stretching ratio of about 6 to 10 times, 6 to 9 times, 6 to 8 times, 6 to 7 times, or about 6.0 to 6.5 times, 6.0 to 6.3 times, 6.0 to 6.1 times, or about 6 times, but the present disclosure is not limited thereto.

In one embodiment of the present disclosure, the MD stretching may be performed at a temperature of about 125° C. or less, for example, about 100° C. to 125° C., 100° C. to 120° C., 110° C. to 115° C., 111° C. to 114° C., or 112° C. to 114° C., taking into account the melting temperature of the polyolefin-based resin. If the MD stretching temperature is too high, the total pore volume in the polyolefin-based porous substrate obtained near the melting point of the polyolefin resin may become too small, and thus a problem may occur in which the inherent porosity of the separator cannot be secured, but the present disclosure is not limited thereto.

In one embodiment of the present disclosure, the MD stretching may be performed at a stretching ratio of about 6 times or more at a temperature of about 100° C. to 125° C., and may be performed at a stretching ratio of about 6.0 to 6.5 times at a temperature of, for example, about 110° C. to 115° C., but the present disclosure is not limited thereto.

In this specification, the ‘stretching ratio’ of the stretching process refers to a ratio of the length of the polymer sheet after stretching to the length of the polymer sheet before stretching.

In one embodiment of the present disclosure, the TD stretching may be performed subsequently to the MD stretching. Here, as the crystallinity of the polymer sheet increases through the MD stretching, the TD stretching may be performed at a temperature higher than that of the MD stretching in a certain range. However, if the difference between the TD stretching temperature and the MD stretching temperature is greater than a certain level, conversely, a problem may be caused in which the amount of pore formation is reduced again. For example, the difference between the temperature at which the TD stretching is performed and the temperature at which the MD stretching is performed may be less than 20° C.

In one embodiment of the present disclosure, the difference between the temperature at which the TD stretching is performed and the temperature at which the MD stretching is performed may be less than about 20° C., or may be, for example, about 5° C. or more and less than 20° C., 10° C. or more and less than 20° C., 15° C. or more and less than 20° C., 15° C. to 19° C., 16° C. to 18° C., or 18° C., but the present disclosure is not limited thereto.

In one embodiment of the present disclosure, if a difference between the MD stretching temperature and the TD stretching temperature is less than about 5° C., for example, about 4° C. or less, 3° C. or less, 2° C. or less, or 1° C. or less, or if the MD stretching and the TD stretching are performed at the same temperature, a problem may occur in which the TD stretching may not be performed or the uniformity of pores of the polymer sheet obtained after the TD stretching may be reduced.

In one embodiment of the present disclosure, the stretching ratio for the TD stretching may be about 4 to 10 times, 4 to 9.5 times, 5 to 9 times, 6 to 8.5 times, 7 to 8.5 times, 7.5 to 8.5 times, 7.8 to 8.2 times, 8.0 to 8.2 times or 8 to 8.2 times, but the present disclosure is not limited thereto.

In one embodiment of the present disclosure, the TD stretching may be performed at a higher temperature than the MD stretching. When the TD stretching is performed at a higher temperature than the MD stretching, an advantageous effect may be exhibited in terms of pore formation and separator permeability, but the present disclosure is not limited thereto.

In one embodiment of the present disclosure, the TD stretching may be performed at a stretching ratio of about 4 to 10 times at a temperature of about 125° C. to 135° C., and may be performed at a stretching ratio of about 7.8 to 8.2 times at a temperature of, for example, about 127° C. to 132° C., but the present disclosure is not limited thereto.

In one embodiment of the present disclosure, after the polymer sheet is stretched in the MD and the TD, a process of removing the diluent used in the previous step may be further performed.

In one embodiment of the present disclosure, in order to remove the diluent, a process of extracting and removing the diluent by using an appropriate solvent may be performed. A solvent that can be used for removing the diluent is not particularly limited, and any solvent capable of extracting the diluent used in the extrusion step may be used. For example, it is possible to use methyl ethyl ketone, methylene chloride, hexane, etc. which have high extraction efficiency and high drying speed, and methylene chloride may be used. As for the extraction method, all general solvent extraction methods such as an immersion method, a solvent spray method, and an ultrasonic method, may be used individually or in combination.

In one embodiment of the present disclosure, the amount of the diluent remaining in the polymer sheet formed after extraction of the diluent may be about 1 wt % or less relative to the total weight of the polymer sheet. If the amount of the remaining diluent exceeds about 1 wt %, there may be a problem of deterioration in physical properties and a decrease in permeability of the separator, but the present disclosure is not limited thereto.

In the step (S3), heat is applied to the above polymer sheet that has pores formed through removal of the diluent while the sheet is stretched in the MD and/or TD. This serves to lower the heat shrinkage properties and may be performed according to the method according to one embodiment.

According to one embodiment of the present disclosure, in the manufacturing method, the heat-setting may be performed at a temperature equal to or higher than the TD stretching temperature so that the total pore volume of the obtained polyolefin-based porous substrate may be realized in a range of about 0.45 cc/g to 1.5 cc/g.

For example, the heat-setting may be performed at a temperature equal to the TD stretching temperature, or at a temperature higher than the TD stretching temperature in a range of about 5° C. or less. For example, the heat-setting may be performed at a temperature equal to the TD stretching temperature or at a temperature higher than the TD stretching temperature by about 5° C., 4° C., 3° C. or 2° C., but the present disclosure is not limited thereto.

In one embodiment of the present disclosure, the heat-setting may be performed at a temperature of, for example, about 125° C. or more, or at about 125° C. to 140° C., 130° C. to 140° C., 130° C. to 135° C., 130° C. to 132° C. or 131° C. to 132° C., but the present disclosure is not limited thereto.

In one embodiment of the present disclosure, during the application of the heat in the heat-setting, the heat may be applied in a state where tension is applied in the MD and/or TD so as to prevent or suppress shrinkage of the porous sheet. Although the heat-setting is not performed for the purpose of stretching in the MD and/or TD, the polymer sheet may be stretched within a predetermined range during this process. Here, the stretching ratio in the MD and/or TD may be measured as, for example, about 1.0 to 1.5 times, or about 1.0 to 1.3 times, 1.1 to 1.2 times or 1.0 to 1.1 times, but the present disclosure is not limited thereto.

According to one embodiment of the present disclosure, the above-obtained polyolefin-based porous substrate may be made of only pores which are empty spaces between polyolefin fibers and polyolefin. Thus, according to one aspect of the present disclosure, it is possible to obtain the polyolefin-based porous substrate with a thickness of about 8 μm or less and a total pore volume of about 0.45 cc/g to 1.5 cc/g.

In one embodiment of the present disclosure, the above-obtained polyolefin-based porous substrate itself may be used as a separator.

In another embodiment of the present disclosure, the step of forming a porous coating layer on at least one surface of the above-obtained polyolefin-based porous substrate may be further performed so that it is possible to obtain a separator including the porous coating layer on at least one surface of the polyolefin-based porous substrate.

In one embodiment of the present disclosure, as described above, the porous coating layer may be formed through a safety reinforced separator (SRS) manufacturing method, a ceramic coated separator (CCS) manufacturing method, or other known manufacturing methods, but the present disclosure is not limited thereto.

In one embodiment of the present disclosure, the porous coating layer may be formed by using a porous coating layer forming slurry containing the inorganic particles and the binder. Here, the weight ratio of the inorganic particles to the binder may be about 99:1 to 50:50, for example, about 95:5 to 60:40, 90:10 to 80:20 or 70:30 to 80:20, but the present disclosure is not limited thereto.

### Electrode Assembly

According to another aspect of the present disclosure, provided is an electrode assembly that includes the above-described separator, and a positive electrode and a negative electrode which are formed on both surfaces of the separator, respectively.

As described above, the separator according to one aspect of the present disclosure has a characteristic that a total pore volume is maintained within a predetermined range even after compression and thus the resistance of the battery is reduced. Therefore, when the electrode assembly is manufactured using the above separator, a characteristic may be exhibited in which a porosity may be secured above a predetermined range within the separator even after lamination of the electrodes and the separator.

Hereinafter, as an example, the configuration of the electrode will be described. However, the present disclosure is not limited thereto.

In one embodiment of the present disclosure, each of the positive electrode and the negative electrode may be obtained by coating a current collector with an electrode active material, and the size, shape, and type of the active material thereof are not particularly limited.

In one embodiment of the present disclosure, in order to check the short-circuit defect rate of the electrode assembly utilizing the above separator, the positive electrode and the negative electrode may be used, and their types are not particularly limited.

For example, the electrode assembly may include, as the positive electrode active material, for example, lithium transition metal oxide; lithium metal iron phosphate; lithium nickel-manganese-cobalt oxide; an oxide obtained by substituting a part of lithium nickel-manganese-cobalt oxide with another transition metal; or two or more of these, but the present disclosure is not limited thereto. For example, examples of the positive electrode active material may include: layered compounds such as lithium cobalt oxide (LiCoO₂) and lithium nickel oxide (LiNiO₂) or compounds substituted with one or more transition metals; lithium manganese oxide of a chemical formula Li₁₊ₓMn₂₋ₓO₄ (where x is 0 to 0.33) such as LiMnO₃, LiMn₂O₃, and LiMnO₂; lithium copper oxide (Li₂CuO₂); vanadium oxide such as LiV₃O₈, LiV₃O₄, V₂O₅, and Cu₂V₂O₇, Ni site-type lithium nickel oxide represented by a chemical formula LiNi₁₋ₓMₓO₂ (where M=Co, Mn, Al, Cu, Fe, Mg, B or Ga, and x=0.01 to 0.3); lithium manganese composite oxide represented by a chemical formula LiMn₂₋ₓMₓO₂ (where M=Co, Ni, Fe, Cr, Zn or Ta, and x=0.01 to 0.1) or Li₂Mn₃MO₈ (where M=Fe, Co, Ni, Cu or Zn); lithium metal phosphate LiMPO₄ (where M=Fe, CO, Ni, or Mn); lithium nickel-manganese-cobalt oxide Li₁₊ₓ(NiₐCO_{b}Mn_{c})₁₋ₓO₂(x=0 to 0.03, a=0.3 to 0.95, b=0.01 to 0.35, c=0.01 to 0.5, and a+b+c=1); an oxide Liₐ[Ni_{b}Co_{c}Mn_{d}Alₑ]_{1-f}M1_{f}O₂ in which a part of lithium nickel-manganese-cobalt oxide is substituted with aluminum (M1 is at least one type selected from Zr, B, W, Mg, Ce, Hf, Ta, La, Ti, Sr, Ba, F, P, and S, 0.8≤a≤1.2, 0.5≤b≤0.99, 0<c<0.5, 0<d<0.5, 0.01≤e≤0.1, and 0≤f≤0.1); an oxide Li₁₊ₓ(NiₐCo_{b}Mn_{c}M_{d})₁₋ₓO₂ in which a part of a lithium nickel-manganese-cobalt oxide is substituted with another transition metal (x=0 to 0.03, a=0.3 to 0.95, b=0.01 to 0.35, c=0.01 to 0.5, d=0.001 to 0.03, a+b+c+d=1, and M is any one selected from Fe, V, Cr, Ti, W, Ta, Mg, and Mo), a disulfide compound; and Fe₂(MoO₄)₃, but are not limited thereto.

For example, examples of the negative electrode active material that may be used for the electrode assembly may include: carbon such as non-graphitizable carbon, or graphite-based carbon; metal composite oxides such as LixFe₂O₃ (0≤x≤1), LiₓWO₂ (0≤x≤1), and SnₓMe₁₋ₓMe′_{y}O_{z}(Me: Mn, Fe, Pb, or Ge; Me′: Al, B, P, Si, elements of groups 1, 2, and 3 of the periodic table, or halogen; 0<x≤1; 1≤y≤3; 1≤z≤8); lithium metal; lithium alloys; silicon-based alloys; tin-based alloys; silicon-based oxides such as SiO, SiO/C, and SiO₂; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; and Li—Co—Ni-based materials, but are not limited to these.

In one embodiment of the present disclosure, for example, the positive electrode may be prepared by the following method. First, a positive electrode active material (LiNi_{0.8}Mn_{0.1}Co_{0.1}O₂), a conductive material (carbon black), a dispersant, and a binder resin (PVDF) are mixed with water at a weight ratio of about 97.5:0.7:0.2:1.6, and then a slurry for a positive electrode active material layer is prepared at a concentration of 50 wt % based on components other than water. Next, the slurry is applied to the surface of an aluminum thin film (e.g., thickness 10 μm) and is dried to manufacture a positive electrode having a positive electrode active material layer (for example, thickness 60 μm). The above-described manufacturing method of the positive electrode is merely an example, and is not intended to limit the present disclosure.

In one embodiment of the present disclosure, for example, the negative electrode may be prepared by the following method. First, artificial graphite, carbon black, carboxymethyl cellulose (CMC), and a binder resin (SBR) are mixed with water at a weight ratio of about 97.5:0.7:1.1:0.7 and then a slurry for a negative electrode active material layer is prepared at a concentration of about 50 wt % based on components other than water. Next, the slurry is applied to the surface of a copper thin film (e.g., thickness 10 μm) and is dried to manufacture a negative electrode having a negative electrode active material layer (for example, thickness 60 μm). The above-described manufacturing method of the negative electrode is merely an example, and is not intended to limit the present disclosure.

According to one embodiment of the present disclosure, the electrode assembly includes a structure of a negative electrode/a separator/a positive electrode that are sequentially stacked. Then, in order to measure the defect rate of the electrode assembly, insulation may be tested using a known Hi-pot tester. For example, after at least 20 electrode assembly samples are prepared, the defect rate can be measured by checking whether insulation breakdown occurs when current is applied under the conditions of 50 V and <0.5 mA (Charging time: 50 ms, test time: 50 ms) by using a Hi-pot tester (Chroma, Model 19052).

According to one embodiment of the present disclosure, when the defect rate of the electrode assembly is measured by the above-described method, among 20 samples, the electrode assembly utilizing the above separator may achieve an effect of exhibiting a defect rate of 0%.

According to another embodiment of the present disclosure, when the defect rate of the electrode assembly is measured by the above-described method, as the number (n) of electrode assembly samples increases, an effect of exhibiting a defect rate of 1% or less, or 0.5% or less may be implemented even if 100≤n, but the present disclosure is not limited thereto.

After the separator is obtained as described above, the electrode assembly according to another aspect of the present disclosure may be manufactured by, for example, a manufacturing method including the steps of interposing a positive electrode and a negative electrode with the separator therebetween and laminating the obtained stack of positive electrode/separator/negative electrode. However, the manufacturing method of the electrode assembly of the present disclosure is not limited thereto.

According to one embodiment of the present disclosure, in the lamination step, a hot-press process may be used.

For example, in the hot press, a hot press machine may be used to apply a temperature and a pressure to the stack of positive electrode/separator/negative electrode so that the positive electrode, the separator, and the negative electrode in the stack are bonded together.

In one embodiment of the present disclosure, the hot press may be performed at a temperature of, for example, about 55° C. to 75° C., 55° C. to 70° C., 60° C. to 65° C., or 60° C., but the present disclosure is not limited thereto.

In one embodiment of the present disclosure, the hot press may be performed at a pressure of, for example, about 5 MPa to 8 MPa, 5 MPa to 7 MPa, 6 MPa to 6.5 MPa or 6.0 MPa to 6.5 MPa, but the present disclosure is not limited thereto.

In one embodiment of the present disclosure, the hot press may be performed under conditions of 60° C. and 6.5 MPa, but the present disclosure is not limited thereto.

### Electrochemical Device

According to another aspect of the present disclosure, an electrochemical device may be provided in which the above-described electrode assembly is housed in a case.

In one embodiment of the present disclosure, examples of the electrochemical device may include a primary battery, a secondary battery, a supercapacitor, and an electric double-layer capacitor. The secondary battery may be a lithium ion secondary battery.

In one embodiment of the present disclosure, the case is a battery case, and is not particularly limited in its external shape based on the intended use of the battery. For example, the case may have a cylindrical shape using a can, a prismatic shape, a pouch shape or a coin shape.

After being completed, the above electrode assembly may be housed in the case and may be sealed to manufacture an electrochemical device. Here, the electrochemical device may be, for example, a lithium secondary battery.

Hereinafter, the present disclosure will be described in more detail through Examples, but the following examples are intended to illustrate the present disclosure and the scope of the present disclosure is not limited to these.

### [Manufacturing of Polyolefin Porous Substrate]

A polyolefin porous substrate was manufactured by the following method.

9 kg of high-density polyethylene (HDPE) (Korea Petrochemical, VH035) and 21 kg of diluent (Kukdong Oil & Chemicals, LP350F) were fed into an extruder (Hankook E. M, φ32 twin-screw extruder L/D=56), and melt-extruded at 200° C. to obtain a polyethylene melt-extrudate. The obtained melt-extrudate was passed through a T-die, and then was cooled using a cooling casting device at a temperature of 40° C. and a running speed of 7 m/min and was molded into a sheet shape. Then, this was MD-stretched and then TD-stretched using a tenter-type sequential stretching machine. From the stretched polyolefin, the diluent was extracted by using methylene chloride to form a porous film. Then, in a state where tension was applied in the TD direction, heat-setting (stretching ratio: 1.2 times) was performed to obtain a polyolefin substrate.

The conditions for the stretching process and the heat-setting process were based on those described in Table 1 below, and the thicknesses of the prepared porous substrates were also measured and noted in Table 1.

The thickness of the porous substrate was measured by using a thickness measuring device (Mitutoyo, VL-50S-B, tip diameter 9.5 mm, Spherical Radium 10 mm).

TABLE 1

| | | MD stretching | | TD stretching | | Heat-setting |
|---|---|---|---|---|---|---|
| | Thickness | Temperature | Stretching | Temperature | Stretching | Temperature |
| Index | (μm) | (° C.) | ratio (times) | (° C.) | ratio (times) | (° C.) |
| Ex. 1 | 8 | 112 | 6 | 130 | 8 | 132 |
| Ex. 2 | 7 | 111 | 6 | 127 | 7.8 | 131 |
| Ex. 3 | 7 | 114 | 6 | 132 | 8.2 | 132 |
| Comp. | 9 | 112 | 6 | 130 | 8 | 132 |
| Ex. 1 | | | | | | |
| Comp. | 7 | 110 | 5.8 | 126 | 7.7 | 131 |
| Ex. 2 | | | | | | |
| Comp. | 7 | 114 | 6.3 | 134 | 8.3 | 131 |
| Ex. 3 | | | | | | |

### [Measurement of Total Pore Volume Before and After Compression]

The total pore volume of the above-prepared porous substrate was measured by using a water intrusion-type aquapore machine (Poretech Instrument, WMI-5K) through the following method.

First, water was injected at a pressure of 150 to 1,800 psi until the saturation state of pores of the polyolefin substrate was reached (100 vol %). When the saturation state was reached, the volume (cc/g) of the injected water was measured as a total pore volume.

Next, the prepared porous substrate was compressed by using a hot press machine (QMESYS, QM900A-U5) under conditions of 60° C. and 6.5 MPa for 10 sec. Then, the total pore volume of the extruded porous substrate was measured in the same manner as described above.

TABLE 2

| | Total pore | Total pore |
|---|---|---|
| | volume before | volume after |
| | compression | compression |
| Index | (unit: cc/g) | (unit: cc/g) |
| Example 1 | 1.05 | 0.8 |
| Example 2 | 0.64 | 0.52 |
| Example 3 | 1.40 | 0.96 |
| Comparative | 1.1 | 0.71 |
| Example 1 | | |
| Comparative | 0.43 | 0.38 |
| Example 2 | | |
| Comparative | 1.58 | 0.41 |
| Example 3 | | |

### [Manufacturing and Performance Evaluation of Lithium Secondary Battery]

A lithium secondary battery was manufactured by using the above-prepared polyolefin-based porous substrate in the following order. Then, the battery resistance and the capacity retention rate for 200 cycles of charging/discharging were evaluated.

### Manufacturing of Separator

A porous coating layer was formed on each of the two surfaces of the above-prepared polyolefin-based porous substrate through an SRS (Safety Reinforced Separator) method (humidification phase-separation method).

A slurry obtained by mixing a PVDF-HFP binder (Mw 500,000 g/mol, HFP 15 wt %) and inorganic particles (Al₂O₃) at a weight ratio of 20:80 was applied and then was dried under humidification conditions to form a porous coating layer.

Here, the porous coating layers were formed such that each porous coating layer formed on one surface of the porous substrate had a thickness of 2.5 μm, and the sum of thicknesses of the porous coating layers in the separator became 5.0 μm.

### Manufacturing of Positive Electrode

A positive electrode active material (LiNi_{0.8}Mn_{0.1}Co_{0.1}O₂), a conductive material (carbon black), a dispersant, and a binder resin (PVDF) were mixed with water at a weight ratio of 97.5:0.7:0.2:1.6, and then a slurry for a positive electrode active material layer was prepared at a concentration of 50 wt % based on components other than water. Next, the slurry was applied to the surface of an aluminum thin film (thickness 10 μm) and was dried to manufacture a positive electrode having a positive electrode active material layer (thickness 60 μm).

### Manufacturing of Negative Electrode

Artificial graphite, carbon black, carboxymethyl cellulose (CMC), and a binder resin (SBR) were mixed with water at a weight ratio of 97.5:0.7:1.1:0.7 and then a slurry for a negative electrode active material layer was prepared at a concentration of 50 wt % based on components other than water. Next, the slurry was applied to the surface of a copper thin film (thickness 10 μm) and was dried to manufacture a negative electrode having a negative electrode active material layer (thickness 60 μm).

### Lamination of Separator and Electrodes

The prepared negative electrode and the positive electrode were stacked with the separator interposed therebetween, and then a lamination process was performed by using a hot press under conditions of 60° C. and 6.5 MPa for 10 sec to obtain an electrode assembly.

### Assembly of Pouch Cell

The above-obtained electrode assembly was inserted into an Al-pouch, and then an electrolyte having a composition of 1 M of LiPF₆, ethyl carbonate (EC) and ethyl methyl carbonate (EMC) (3/7 v/v), and 2 wt % of vinylene carbonate (VC) was injected to prepare a pouch-type monocell.

### Measurement of Resistance (Ω) and Capacity Retention Rate (%) of Monocell

The above-prepared pouch-type monocell was charged to 50% of state of charge (SOC), and then current was applied at a 2.5 C-rate for 10 sec to measure a cell resistance.

Next, the above-prepared pouch-type monocell was charged at a 1 C rate within a voltage range of 2.5 V to 4.2 V at a room temperature (25° C.) and was discharged at a 1 C rate (CC/CC). This was set as one cycle, and then in comparison to the one-cycle discharge capacity, the 200-cycle discharge capacity was measured, thereby evaluating the capacity retention rate (%) for 200 cycles.

TABLE 3

| | | Capacity |
|---|---|---|
| | Cell | Retention Rate |
| | Resistance | After 200 |
| Index | (Ω) | Cycles (%) |
| Example 1 | 0.37 | 94 |
| Example 2 | 0.39 | 92 |
| Example 3 | 0.35 | 95 |
| Comparative | 0.51 | 90 |
| Example 1 | | |
| Comparative | 0.45 | 85 |
| Example 2 | | |
| Comparative | 0.34 | 88 |
| Example 3 | | |

Referring to the above experimental results, as in Comparative Example 1, when the polyolefin-based porous substrate in the separator was formed with a thickness of greater than 8 μm, it was found that the cell resistance was increased and the capacity retention rate was also reduced due to the inherent insulation properties of the separator. For example, it can be found that in Example 1, when the thickness of the porous substrate was 8 μm, the cell resistance was 0.37Ω and the capacity retention rate was 94% whereas in Comparative Example 1, as the thickness of the separator was increased to 9 μm, the cell resistance was increased to 0.51Ω, and the capacity retention rate was reduced to 90%. Also, referring to Comparative Example 2, even if the polyolefin-based porous substrate was realized with a thickness of 8 μm or less, when the total pore volume was less than 0.45 cc/g, a sufficient pore volume cannot be secured after compression in the battery assembly process, and the resistance was increased. Thus, it was found that the battery life was degraded due to a decrease in capacity as the charging/discharging cycle was repeated. For example, it can be found that in Example 2, the total pore volume was 0.64 cc/g and a capacity retention rate of 92% was exhibited whereas in Comparative Example 2, the total pore volume was decreased to 0.43 cc/g, and the capacity retention rate was also decreased to 85%. Also, referring to Comparative Example 3, even if the polyolefin-based porous substrate was realized with a thickness of 8 μm or less, when the total pore volume was greater than 1.5 cc/g, conversely, the compression resistance of the porous substrate was poor. Thus, it was found that the total pore volume was not secured after compression, thereby increasing a resistance and also degrading a capacity retention rate. For example, it can be found that in Example 3, the total pore volume was 1.40 cc/g and a capacity retention rate of 95% was exhibited whereas in Comparative Example 3, although the porous substrate had the same thickness of 7 μm, the total pore volume was increased to 1.58 cc/g and the capacity retention rate was decreased to 88%.

The above detailed description is intended to illustrate and explain the present disclosure. Also, the foregoing description merely illustrates and describes embodiments of the present disclosure. As described above, the present disclosure may be used in various combinations, modifications, and environments, and can be modified or changed within the scope of the invention disclosed in this specification, the scope equivalent to the above-described disclosure and/or the range of the skill or knowledge of the art. Therefore, the above detailed description of the invention is not intended to limit the invention to the disclosed embodiments. Also, the appended claims should be construed to encompass other embodiments as well.

What is claimed is:

1. A separator comprising:
a polyolefin-based porous substrate having a thickness of about 8 μm or less,
wherein the total pore volume within the polyolefin-based porous substrate is about 0.45 cc/g to 1.5 cc/g.

2. The separator according to claim 1, wherein
the total pore volume is obtained by injecting moisture into the polyolefin-based porous substrate at a constant pressure and measuring the total amount of moisture injected until the moisture saturation reaches 100 volume %.

3. The separator according to claim 1, wherein
the thickness of the polyolefin-based porous substrate is about 5 μm to 8 μm.

4. The separator according to claim 1, wherein
the polyolefin-based porous substrate is manufactured by a wet method, and
the wet method is a method including an extrusion process and a stretching process using a raw material of a polyolefin-based resin mixed with a diluent.

5. The separator according to claim 1, further comprising:
a porous coating layer being located on at least one surface of the polyolefin-based porous substrate, and including inorganic particles and a binder,
wherein the thickness of the porous coating layer formed on one surface is about 20% to 45% relative to the thickness of the separator.

6. The separator according to claim 5, wherein
the separator includes a porous coating layer on each of the two surfaces of the polyolefin-based porous substrate,
the sum of thicknesses of the porous coating layers is about 40% to 80% relative to the thickness of the separator.

7. A separator manufacturing method comprising:
obtaining a polymer sheet by extruding, cooling, and molding a mixture of a polyolefin resin raw material and a diluent;
stretching the obtained polymer sheet in MD (Machine Direction) and TD (Transverse Direction); and
heat-setting the stretched polymer sheet to obtain a polyolefin-based porous substrate,
wherein the MD stretching is performed at a stretching ratio of 6 times or more,
a difference between the temperature for the TD stretching and the temperature for the MD stretching is less than 20° C., and
the thickness of the polyolefin-based porous substrate is about 8 μm or less.

8. The separator manufacturing method according to claim 7, wherein
the MD stretching is performed at a stretching ratio of about 6 to 10 times at a temperature of about 100° C. to 125° C.

9. The separator manufacturing method according to claim 7, wherein
the TD stretching is performed at a stretching ratio of about 4 to 10 times at a temperature of about 125° C. to 135° C.

10. The separator manufacturing method according to claim 7, wherein
the heat-setting is performed at a temperature of about 130° C. to 140° C.

11. The separator manufacturing method according to claim 7, wherein
the total pore volume within the polyolefin-based porous substrate is about 0.45 cc/g to 1.5 cc/g.

12. The separator manufacturing method according to claim 7, further comprising:
forming a porous coating layer by applying and drying slurry containing inorganic particles and a binder to at least one surface of the polyolefin-based porous substrate.

13. The separator manufacturing method according to claim 12, wherein
the thickness of the porous coating layer formed on one surface is about 20% to 45% relative to the thickness of the separator.

14. An electrode assembly comprising:
the separator according to claim 1; and
a positive electrode and a negative electrode being provided on both surfaces of the separator, respectively.

15. An electrochemical device comprising:
the electrode assembly according to claim 14; and
a case configured to accommodate the electrode assembly.

16. The separator according to claim 5, wherein
the porous coating layer is manufactured by a safety reinforced separator (SRS) manufacturing method.

17. The separator manufacturing method according to claim 7, wherein
the extruding is performed through melt-extrusion at a temperature of about 170° C. to 250° C.
